(19) United States
(12) Patent Application Publication
(10) Pub. No.: US 2023/0405853 A1
(43) Pub. Date: Dec. 21, 2023

(54) Hair Clipper Assembly

(71) Applicants: Shannette Perry, Manor, TX (US); Adarryll Perry, Manor, TX (US)

(72) Inventors: Shannette Perry, Manor, TX (US); Adarryll Perry, Manor, TX (US)

(21) Appl. No.: 17/843,338

(22) Filed: Jun. 17, 2022

(51) Int. Cl. B26B 19/38; B26B 19/28; B26B 19/48

(52) U.S. Cl. CPC B26B 19/382; B26B 19/28; B26B 19/3853; B26B 19/48; B26B 19/3886; B26B 19/3873

(57) ABSTRACT

A hair clipper assembly for enhancing the experience of employing a hair clipper includes a hair clipper that has a handle portion and a pair of blades that are movably disposed on the handle portion. The blades are urged to move back and forth when the hair clipper is turned on for cutting hair. An audio unit is integrated into the hair clipper and the audio unit stores a database comprising digital music. The audio unit emits audible sounds from the hair clipper comprising the digital music to entertain a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to clipper devices and more particularly pertains to a new clipper device for enhancing the experience of employing a hair clipper.

### (2) Description of Related Art Including Information Disclosed Under 37 CFR 1.97 and 1.98

The prior art relates to clipper devices including an electric hair clipper which includes blades and an electric motor. The prior art discloses an on/off switch for a hair clipper. The prior art discloses a hair clipper that includes a suction hair collection element. The prior art discloses a hair clipper that includes an electronic control pad for adjusting an operational speed of the hair clipper.

### BRIEF SUMMARY OF THE INVENTION

An embodiment of the disclosure meets the needs presented above by generally comprising a hair clipper that has a handle portion and a pair of blades that are movably disposed on the handle portion. The blades are urged to move back and forth when the hair clipper is turned on for cutting hair. An audio unit is integrated into the hair clipper and the audio unit stores a database comprising digital music. The audio unit emits audible sounds from the hair clipper comprising the digital music to entertain a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a hair clipper assembly according to an embodiment of the disclosure.

FIG. 2 is a back perspective view of an embodiment of the disclosure.

FIG. 3 is a left side view of an embodiment of the disclosure.

FIG. 4 is a right side phantom view of an embodiment of the disclosure.

FIG. 5 is a perspective in-use view of an embodiment of the disclosure.

### DETAILED DESCRIPTION OF THE INVENTION

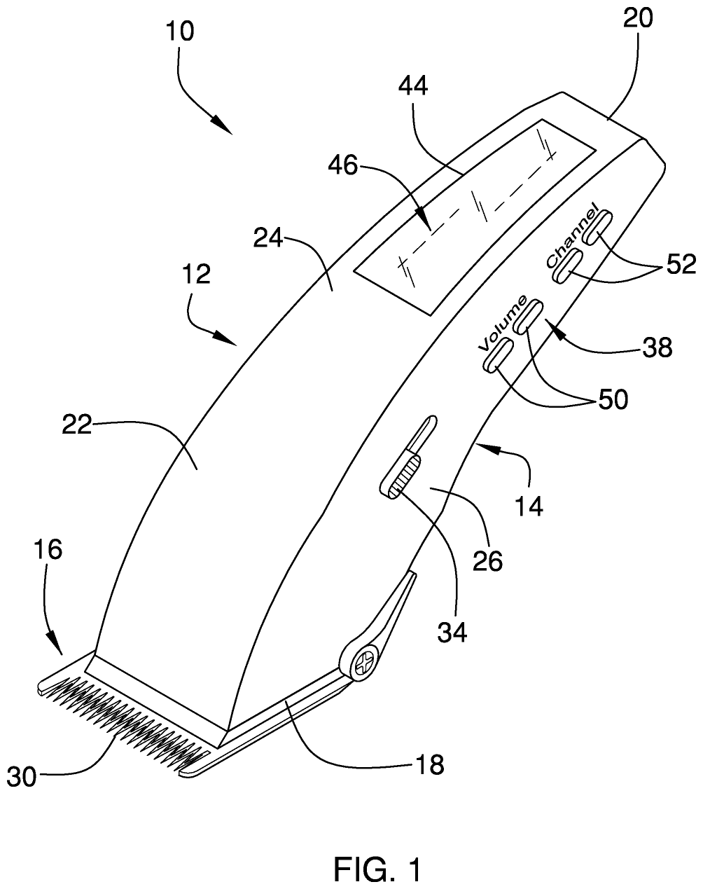

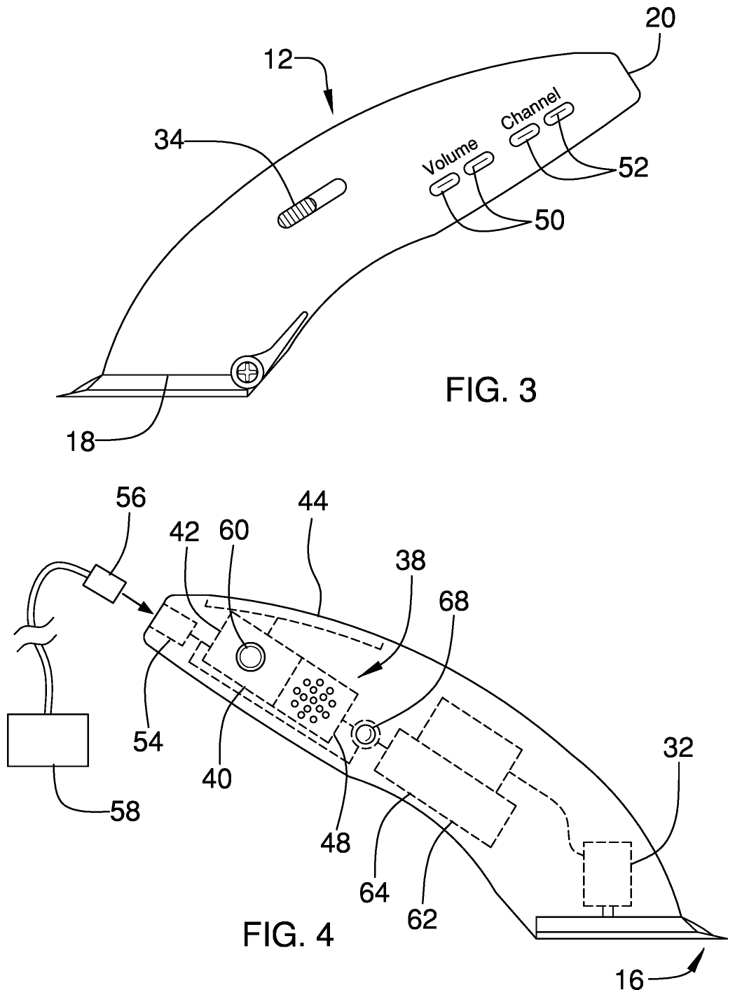

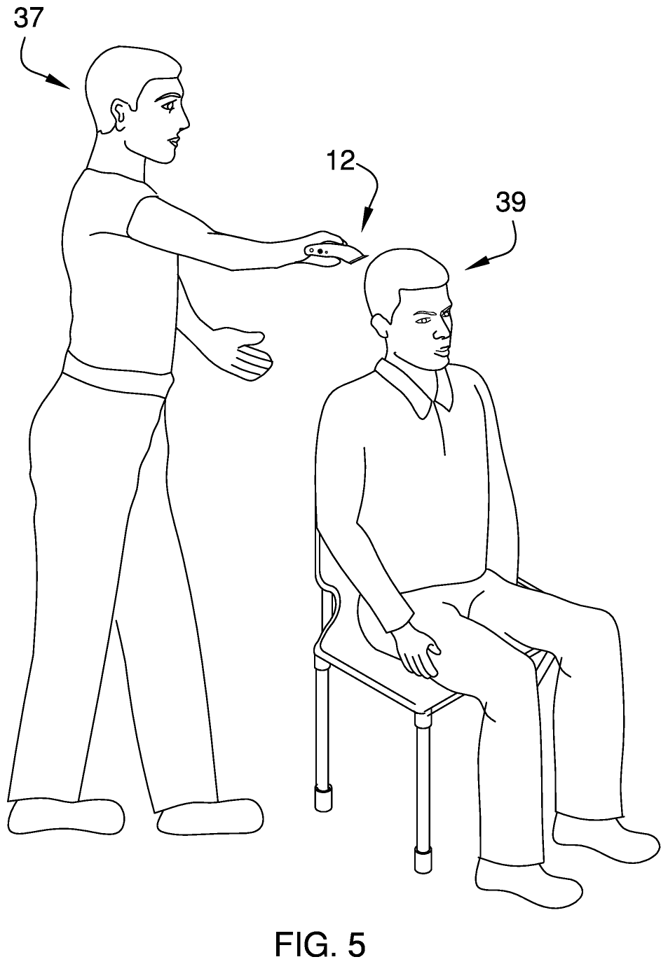

With reference now to the drawings, and in particular to FIGS. 1 through 5 thereof, a new clipper device embodying the principles and concepts of an embodiment of the disclosure and generally designated by the reference numeral 10 will be described.

As best illustrated in FIGS. 1 through 5, the hair clipper assembly 10 generally comprises a hair clipper 12 has a handle portion 14 and a pair of blades 16 movably disposed on the handle portion 14. The blades 16 are urged to move back and forth when the hair clipper 12 is turned on for cutting hair. The handle portion 14 has a lower end 18, an upper end 20 and an outer wall 22 extending between the lower end 18 and the upper end 20, and the outer wall 22 has a front side 24, a first lateral side 26 and a second lateral side 28. Each of the blades 16 is disposed on the lower end 18 of the handle portion 14 and each of the blades 16 has a cutting edge 30. Furthermore, each of the blades 16 extends forwardly beyond the front side 24 of the outer wall 22 such that the cutting edge 30 of each of the blades 16 is exposed with respect to the front side 24.

The hair clipper 12 includes a motor 32 that is positioned within the handle portion 14 and the motor 32 is positioned adjacent to the lower end 18. The motor 32 is in mechanical communication with the blades 16 for urging the blades 16 back and forth when the motor 32 is turned on. Additionally, the motor 32 may comprise an electric motor or the like and the motor 32 may comprise a low noise motor which is designed to reduce the noise level of the hair clipper 12. The hair clipper 12 includes a power switch 34 that is slidably integrated into the first lateral side 26 of the outer wall 22 of the handle portion 14, and the power switch 34 is electrically coupled to the motor 32 for turning the motor 32 on and off. The second lateral side 28 of the outer wall 22 of the handle portion 14 has a plurality of speaker holes 36 each extending into an interior of the handle portion 14, and the speaker holes 36 are arranged to form a circle.

An audio unit 38 is integrated into the hair clipper 12 and the audio unit 38 stores a database comprising digital music. The audio unit 38 emits audible sounds from the hair clipper 12 which comprise the digital music to entertain a user 37. Furthermore, the audible sounds help to conceal the sound of the hair clipper 12 when the hair clipper 12 is turned on. In this way audio unit 38 can ease the fears of a patron 39, such as a child for example, that is getting a hair cut.

The audio unit 38 comprises a control circuit 40 that is integrated into the handle portion 14 of the hair clipper 12. The control circuit 40 includes an electronic memory 42 and the electronic memory 42 stores the database comprising the digital music. A display 44 is coupled to the front side 24 of the outer wall 22 of the handle portion 14 and the display 44 is electrically coupled to the control circuit 40. Furthermore, the display 44 displays indicia 46 comprising letters and numbers for communicating information about the digital music. The display 44 may comprise a liquid crystal display or other type of electronic display.

The audio unit 38 includes a speaker 48 that is positioned within the handle portion 14. The speaker 48 is aligned with the plurality of speaker holes 36 in the second lateral side 28 of the outer wall 22 of the handle portion 14. Additionally, the speaker 48 is electrically coupled to the control circuit 40 thereby facilitating the speaker 48 to emit the digital music outwardly through the speaker holes 36. A volume control 50 is movably integrated into the first lateral side 26 of the outer wall 22 of the handle portion 14. The volume control 50 is electrically coupled to the control circuit 40 and the volume control 50 adjusts a volume of the speaker 48 between a minimum volume and a maximum volume.

The audio unit 38 includes a channel control 52 that is movably integrated into the first lateral side 26 of the outer wall 22 of the handle portion 14. The channel control 52 is electrically coupled to the control circuit 40 and the channel control 52 advances or replays songs that are played with respect to the digital music. An input port 54 is recessed into the upper end 20 of the handle portion 14 of the hair clipper 12 and the input port 54 is electrically coupled to the control circuit 40. The input port 54 receives a data cable 56 from a data source 58 thereby facilitating the digital music to be downloaded into the electronic memory 42. The input port 54 may comprise a universal serial bus port or other similar type of data port. The data cable 56 may be a universal serial bus port cable and the data source 58 may be a smart phone or other type of personal electronic device.

The audio unit 38 includes a download button 60 that is movably integrated into the second lateral side 28 of the outer wall 22 of the handle portion 14. The download button 60 is electrically coupled to the control circuit 40 and the control circuit 40 is actuated to perform a download sequence when the download button 60 is depressed to facilitate the digital music to be downloaded into the electronic memory 42. A power supply 62 is integrated into the handle portion 14 of the hair clipper 12 and the power supply 62 is electrically coupled to the control circuit 40 and the motor 32.

The power supply 62 comprises a rechargeable battery 64 that is positioned within the handle portion 14 and the rechargeable battery 64 is electrically coupled to the motor 32 and the control circuit 40. The rechargeable battery 64 is electrically coupled to the input port 54 for charging the rechargeable battery 64 when a charge cord 66 is inserted into the input port 54. An indicator 68 is integrated into the second lateral side 28 of the outer wall 22 of the handle portion 14. The indicator 68 is electrically coupled to the rechargeable battery 64 and the indicator 68 emits a visual indication of a charge level of the rechargeable battery 64. The indicator 68 may comprise a light emitting diode or other type of electronic indicator. Furthermore, the indicator 68 may emit a first visual indication to communicate an operational charge and a second visual indication to communicate a low charge.

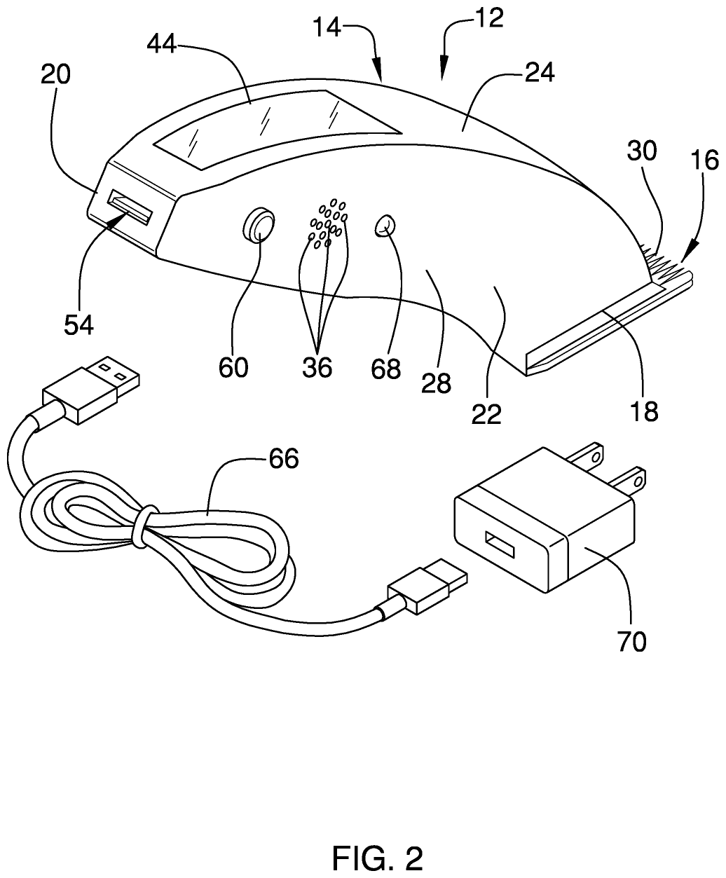

In use, the digital music is downloaded into the electronic memory 42 and the digital music is played through the speaker 48 while the hair clipper 12 is being employed. In this way the music conceals the noise of the hair clipper 12 while the hair clipper 12 is being employed. Additionally, the music enhances the user's 37 enjoyment and the patron's 39 enjoyment during a hair cut. As is most clearly shown in FIG. 2, a charger 70 is provided which includes the charge cord 66 and the charge cord 66 can be inserted into the input port 54 for charging the rechargeable battery 64. The volume control 50 and the channel control 52 can be manipulated to control the volume of the music and to advance or replay songs.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hair clipper assembly for streaming music while cutting hair, said assembly comprising:
a hair clipper having a handle portion and a pair of blades movably disposed on said handle portion, said blades being urged to move back and forth when said hair clipper is turned on for cutting hair; and
an audio unit being integrated into said hair clipper, said audio unit storing a database comprising digital music, said audio unit emitting audible sounds from said hair clipper comprising said digital music wherein said audio unit is configured to entertain a user.

2. The assembly according to claim 1, wherein:
said handle portion has a lower end, an upper end and an outer wall extending between said lower end and said upper end, said outer wall having a front side, a first lateral side and a second lateral side;
each of said blades is disposed on said lower end of said handle portion, each of said blades having a cutting edge, each of said blades extending forwardly beyond said front side of said outer wall such that said cutting edge of each of said blades is exposed with respect to said front side;
said clipper includes a motor being positioned within said handle portion, said motor being positioned adjacent to said lower end, said motor being in mechanical communication with said blades for urging said blades back and forth when said motor is turned on;
said hair clipper includes a power switch being slidably integrated into said first lateral side of said outer wall of said handle portion, said power switch being electrically coupled to said motor for turning said motor on and off; and
said second lateral side of said outer wall of said handle portion has a plurality of speaker holes each extending into an interior of said handle portion, said speaker holes being arranged to form a circle.

3. The assembly according to claim 2, wherein said audio unit comprises:
a control circuit being integrated into said handle portion of said hair clipper, said control circuit including an electronic memory, said electronic memory storing said database comprising said digital music;
a display being coupled to said front side of said outer wall of said handle portion, said display being electrically coupled to said control circuit, said display displaying indicia comprising letters and numbers for communicating information about said digital music; and
a speaker being positioned within said handle portion, said speaker aligned with said plurality of speaker holes in said second lateral side of said outer wall of said handle portion, said speaker being electrically coupled to said control circuit thereby facilitating said speaker to emit said digital music outwardly through said speaker holes.

4. The assembly according to claim 3, wherein said audio unit includes:
a volume control being movably integrated into said first lateral side of said outer wall of said handle portion, said volume control being electrically coupled to said control circuit, said volume control adjusting a volume of said speaker between a minimum volume and a maximum volume; and
a channel control being movably integrated into said first lateral side of said outer wall of said handle portion, said channel control being electrically coupled to said control circuit, said channel control advancing or replaying songs being played with respect to said digital music.

5. The assembly according to claim 3, wherein said audio unit includes:
an input port being recessed into said upper end of said handle portion of said hair clipper, said input port being electrically coupled to said control circuit, said input port receiving a data cable from a data source thereby facilitating said digital music to be downloaded into said electronic memory; and
a download button being movably integrated into said second lateral side of said outer wall of said handle portion, said download button being electrically coupled to said control circuit, said control circuit being actuated to perform a download sequence when said download button is depressed to facilitate said digital music to be downloaded into said electronic memory.

6. The assembly according to claim 5, further comprising a power supply being integrated into said handle portion of said hair clipper, said power supply being electrically coupled to said control circuit and said motor, said power supply comprising:
a rechargeable battery being positioned within said handle portion, said rechargeable battery being electrically coupled to said motor and said control circuit, said rechargeable battery being electrically coupled to said input port for charging said rechargeable battery when a charge cord is inserted into said input port; and
an indicator being integrated into said second lateral side of said outer wall of said handle portion, said indicator being electrically coupled to said rechargeable battery, said indicator emitting a visual indication of a charge level of said rechargeable battery.

7. A hair clipper assembly for streaming music while cutting hair, said assembly comprising:
a hair clipper having a handle portion and a pair of blades movably disposed on said handle portion, said blades being urged to move back and forth when said hair clipper is turned on for cutting hair, said handle portion having a lower end, an upper end and an outer wall extending between said lower end and said upper end, said outer wall having a front side, a first lateral side and a second lateral side, each of said blades being disposed on said lower end of said handle portion, each of said blades having a cutting edge, each of said blades extending forwardly beyond said front side of said outer wall such that said cutting edge of each of said blades is exposed with respect to said front side, said clipper including a motor being positioned within said handle portion, said motor being positioned adjacent to said lower end, said motor being in mechanical communication with said blades for urging said blades back and forth when said motor is turned on, said hair clipper including a power switch being slidably integrated into said first lateral side of said outer wall of said handle portion, said power switch being electrically coupled to said motor for turning said motor on and off, said second lateral side of said outer wall of said handle portion having a plurality of speaker holes each extending into an interior of said handle portion, said speaker holes being arranged to form a circle; and
an audio unit being integrated into said hair clipper, said audio unit storing a database comprising digital music, said audio unit emitting audible sounds from said hair clipper comprising said digital music wherein said audio unit is configured to entertain a user, said audio unit comprising:
a control circuit being integrated into said handle portion of said hair clipper, said control circuit including an electronic memory, said electronic memory storing said database comprising said digital music;
a display being coupled to said front side of said outer wall of said handle portion, said display being electrically coupled to said control circuit, said display displaying indicia comprising letters and numbers for communicating information about said digital music;
a speaker being positioned within said handle portion, said speaker aligned with said plurality of speaker holes in said second lateral side of said outer wall of said handle portion, said speaker being electrically coupled to said control circuit thereby facilitating said speaker to emit said digital music outwardly through said speaker holes;
a volume control being movably integrated into said first lateral side of said outer wall of said handle portion, said volume control being electrically coupled to said control circuit, said volume control adjusting a volume of said speaker between a minimum volume and a maximum volume;
a channel control being movably integrated into said first lateral side of said outer wall of said handle portion, said channel control being electrically coupled to said control circuit, said channel control advancing or replaying songs being played with respect to said digital music;
an input port being recessed into said upper end of said handle portion of said hair clipper, said input port being electrically coupled to said control circuit, said input port receiving a data cable from a data source thereby facilitating said digital music to be downloaded into said electronic memory; and
a download button being movably integrated into said second lateral side of said outer wall of said handle portion, said download button being electrically coupled to said control circuit, said control circuit being actuated to perform a download sequence when said download button is depressed to facilitate said digital music to be downloaded into said electronic memory;
a power supply being integrated into said handle portion of said hair clipper, said power supply being electrically coupled to said control circuit and said motor, said power supply comprising:
a rechargeable battery being positioned within said handle portion, said rechargeable battery being electrically coupled to said motor and said control circuit, said rechargeable battery being electrically coupled to said input port for charging said rechargeable battery when a charge cord is inserted into said input port; and
an indicator being integrated into said second lateral side of said outer wall of said handle portion, said indicator being electrically coupled to said rechargeable battery, said indicator emitting a visual indication of a charge level of said rechargeable battery.
